(19) United States
(12) Patent Application Publication
(10) Pub. No.: US 2020/0205449 A1
(43) Pub. Date: Jul. 2, 2020

(54) HARDENING INHIBITOR FOR BRINE-CONTAINING NOODLES OR BRINE-CONTAINING WONTON WRAPPER

(71) Applicant: YUKI GOSEI KOGYO CO., LTD., Tokyo (JP)

(72) Inventors: Yuki KAMINAGA, Tokyo (JP); Tetsuji NODA, Tokyo (JP); Toshiya ISHII, Gardena (US); Tetsuya KOBAYASHI, Gardena, CA (US)

(73) Assignee: YUKI GOSEI KOGYO CO., LTD., Tokyo (JP)

(21) Appl. No.: 16/616,684

(22) PCT Filed: May 24, 2018
(86) PCT No.: PCT/JP2018/019936

§ 371 Date: Nov. 25, 2019

(30) Foreign Application Priority Data
May 24, 2017 (JP) 2017 102521

(51) Int. Cl. A23L 7/109; A23L 3/3526

(52) U.S. Cl. CPC A23L 7/109; A23V 2002/00; A23L 3/3526

(57) ABSTRACT

The present disclosure relates to a hardening inhibitor of brine-containing noodles or a brine-containing wonton wrapper including an α-amino acid, a β-amino acid, or a γ-amino acid, or a salt thereof.

### TECHNICAL FIELD

The present invention relates to a hardening inhibitor of brine-containing noodles or a brine-containing wonton wrapper. According to the present invention, an excess hardening of noodles or wrapper can be inhibited in an aging of brine-containing noodles or maturation of brine-containing wonton wrapper.

### BACKGROUND ART

Chinese noodles are prepared by using a wheat flour, a brine, and a water. It is possible to obtain the firmness (elasticity) and hue specific to Chinese noodles by using the brine. Specifically, a gluten formed by the effect of brain is considered to give elastic and flexible firmness of Chinese noodles. In addition, the flavonoids contained in the flour are yellowed by the brain and impart a unique color to Chinese noodles. In particular, the firmness specific to Chinese noodles is obtained by preserving and aging in the noodle state.

### CITATION LIST

### Patent Literature

[Patent literature 1] Japanese Unexamined Patent Publication (Kokai) No. 63-157950
[Patent literature 2] Japanese Unexamined Patent Publication (Kokai) No. 2005-253460

### SUMMARY OF INVENTION

### Technical Problem

However, there was a drawback that the Chinese noodles became too hard if the noodles were overly aged.

The object of the present invention is to provide a means to inhibit the hardening of brine-containing noodles in the aging process of noodles.

### Solution to Problem

The present inventors have conducted intensive studies into a means to inhibit the hardening of brine-containing noodles in the aging of noodles, and as a result, surprisingly found that an excessive hardening of the brine-containing noodles can be prevented by adding an amino acid or a salt thereof and aging the noodles in the manufacturing process of the brine-containing noodles.

The present invention is based on the above findings.

Accordingly, the present invention relates to

1. a hardening inhibitor of brine-containing noodles or a brine-containing wonton wrapper, comprising an α-amino acid, a β-amino acid, or a γ-amino acid, or a salt thereof,

2. the hardening inhibitor of brine-containing noodles or a brine-containing wonton wrapper of the item 1, comprising the α-amino acid or the salt thereof,

3. use of an α-amino acid, a β-amino acid, or a γ-amino acid, or a salt thereof, for inhibiting hardening of brine-containing noodles or a brine-containing wonton wrapper,

4. the use of the item 3, of the α-amino acid or the salt thereof, for inhibiting hardening of the brine-containing noodles or the brine-containing wonton wrapper,

5. a method for inhibiting hardening of brine-containing noodles or a brine-containing wonton wrapper, characterized in that an α-amino acid, a β-amino acid, or a γ-amino acid, or a salt thereof is added to the brine-containing noodles or the brine-containing wonton wrapper, for inhibiting hardening of the brine-containing noodles or the brine-containing wonton wrapper,

6. the method for inhibiting hardening of brine-containing noodles or a brine-containing wonton wrapper of the item 5, characterized in that the α-amino acid or the salt thereof is added to the brine-containing noodles or the brine-containing wonton wrapper, for inhibiting hardening of the brine-containing noodles or the brine-containing wonton wrapper,

7. the method for inhibiting hardening of brine-containing noodles or a brine-containing wonton wrapper of the item 5 or 6, the addition amount of the α-amino acid, the β-amino acid, or the γ-amino acid, or the salt thereof with respect to a total weight of the brine-containing noodles is 0.3% by weight to 3% by weight.

Previously, it is disclosed that glycine was conventionally used as a chelating agent to improve the color hue of raw Japanese buckwheat noodles (Patent literature 1). In addition, glycine is known to have a bacteriostatic action or bactericidal action (Patent literature 2). However, it is unused as a hardening inhibitor for brine-containing noodles.

### Advantageous Effects of Invention

According to the hardening inhibitor of the present invention, the excessive hardening of the brine-containing noodles can be prevented in the aging process of the noodles and the like. Further, the noodles with added the amino acid or the salt thereof show a transparent property, that is, it is possible to obtain a transparent physical property that are desired in much hydrated noodles or the like. Furthermore, the noodles with added the amino acid or the salt thereof can be boiled even in highlands with low boiling points.

By using a hardening inhibitor of the present invention, it is possible to make the noodle very soft, and thus it is optimal as a noodle for the elderly.

### DESCRIPTION OF EMBODIMENTS

### Hardening Inhibitor of Brine-Containing Noodles or Brine-Containing Wonton Wrapper

The hardening inhibitor of brine-containing noodles of the present invention comprises comprising an α-amino acid, a β-amino acid, or a γ-amino acid, or a salt thereof. The hardening inhibitor of the present invention can prevent the excessive hardening of the brine-containing noodles in the aging of noodles and the excessive hardening of the brine-containing wonton wrapper.

### Brine-Containing Noodles

The brine-containing noodles is not limited, as long as noodles contains brine, there may be mentioned Chinese noodles, ramen noodles, and pan-fried noodles. Further, the hardening inhibitor of the present invention can be applied to wonton wrapper wherein brine and wheat flour are contained, and the mixture is aged.

Brine is an alkaline salt aqueous solution that can give the noodles softness and elasticity (firmness) by mixing with wheat flour to make noodles. In addition, it can give the Chinese noodles a specific feel and hue.

An active ingredient of brine includes carbonates (such as potassium carbonate, sodium carbonate, or sodium hydrogen carbonate), pyrophosphates (such as tetrapotassium pyrophosphate, disodium dihydrogen pyrophosphate, or tetrasodium pyrophosphate), polyphosphate (such as potassium polyphosphate, or sodium polyphosphate), metaphosphate (such as potassium metaphosphate, or sodium metaphosphate), or phosphate (tripotassium phosphate, dipotassium hydrogen phosphate, potassium dihydrogen phosphate, Disodium hydrogen phosphate, sodium dihydrogen phosphate, or trisodium phosphate).

The amount of brine added to the flour can be appropriately adjusted so as to obtain the active ingredient content in the brine and the desired firmness.

### Amino Acid

An amino acid or a salt thereof used in the present invention is an α-amino acid, β-amino acid, or γ-amino acid, or a salt thereof. The α-amino acid, β-amino acid, or γ-amino acid may be a D-amino acid, a L-amino acid, or a mixture thereof. In this specification, the α-amino acid, β-amino acid, or γ-amino acid, or the salt thereof may be collectively referred to as “amino acid.”

The term α-amino acid as used herein means an amino acid in which an amino group bonded to an α carbon to which a carboxyl group is bonded, and it has a structure of RCH(NH2)COOH. Specifically, there may be mentioned aspartic acid, glutamic acid lysine, arginine, histidine, glycine, alanine, valine, leucine, isoleucine, serine, threonine, cysteine, methionine, asparagine, glutamine, proline, phenylalanine, tyrosine, and tryptophan. Strictly, proline is an imino acid. However, since the effect of the present invention can be obtained thereby, proline is included in the α-amino acid in the present specification.

The term β-amino acid as used herein means an amino acid in which an amino group bonded to a β carbon adjacent to the α carbon to which the carboxyl group is bonded, and it has a structure of RCH(NH2)CH2COOH. Specifically, there may be mentioned β-alanine.

The term γ-amino acid as used herein means an amino acid in which an amino group bonded to a γ carbon adjacent to the β carbon, and it has a structure of RCH (NH2) CH2CH2COOH. Specifically, there may be mentioned γ-aminobutyric acid (GABA).

The amino acid or the salt thereof comprised in the brine-containing noodles and the like of the present invention is not particularly limited, and the above amino acids and the salts thereof may be used without limitation

The salt of the amino acid is not particularly limited, and sodium salt or potassium salt can be used.

The amount of the amino acid or salt thereof in the hardening inhibitor of the present invention in the brine-containing noodles and the like, is not particularly limited, as long as the effects of the present invention are obtained. However, it is preferably 0.3% by weight to 3% by weight with respect to the total weight of the noodles and the like.

Within the above ranges, it is possible to obtain brine-containing noodles in which excessive hardening is inhibited while the noodles have firmness. When the amount of the amino acid or salt thereof exceeds 3% by weight, the noodles may be cut easily.

### Use for Inhibiting Hardening of Brine-Containing Noodles or Brine-Containing Wonton Wrapper

In the use of the present invention, an α-amino acid, β-amino acid, or γ-amino acid, or a salt thereof is used to inhibit the hardening of brine-containing noodles or brine-containing wonton wrapper.

In the use for inhibiting the hardening of the brine-containing noodles and the like, as terms “brine-containing noodles”, “brine-containing wonton wrapper”, and “α-amino acid, β-amino acid, or γ-amino acid, or salt thereof” the same terms described in the above item “Hardening inhibitor of brine-containing noodles or brine-containing wonton wrapper” can be used.

In the use for inhibiting the hardening of the brine-containing noodles and the like, the used amount of the amino acid or salt thereof is not particularly limited, as long as the effects of the present invention are obtained. However, it is preferably 0.3% by weight to 3% by weight with respect to the total weight of the noodles and the like. Within the above ranges, it is possible to obtain brine-containing noodles in which excessive hardening is inhibited while the noodles have firmness. When the used amount of the amino acid or salt thereof exceeds 3% by weight, the noodles may be cut easily.

### Method for Inhibiting Hardening of Brine-Containing Noodles or Brine-Containing Wonton Wrapper

The method for inhibiting hardening of brine-containing noodles or brine-containing wonton wrapper is characterized in that an α-amino acid, or a salt thereof is added to the brine-containing noodles or the like, for inhibiting hardening of the brine-containing noodles or the like.

In the method for inhibiting hardening of brine-containing noodles or the like, as terms “brine-containing noodles”, “brine-containing wonton wrapper”, and “α-amino acid, β-amino acid, or γ-amino acid, or salt thereof”, the same terms described in the above item “Hardening inhibitor of brine-containing noodles or brine-containing wonton wrapper” can be used.

In the method for inhibiting hardening of brine-containing noodles or the like, the additive amount of the amino acid or salt thereof is not particularly limited, as long as the effects of the present invention are obtained. However, it is preferably 0.3% by weight to 3% by weight with respect to the total weight of the noodles and the like. Within the above ranges, it is possible to obtain brine-containing noodles in which excessive hardening is inhibited while the noodles have firmness. When the additive amount of the amino acid or salt thereof exceeds 3% by weight, the noodles may be cut easily.

### Function

In the present invention, the mechanism by which the amino acid or salt thereof can inhibit excessive hardening of brine-containing noodles has not been fully elucidated but is presumed to be as follows. However, the present invention is by no means limited to the following explanation.

In the Chinese noodles, the properties of gluten change due to brine (alkaline), and the Chinese noodles are aged to achieve a special firmness. The amino acid or salt thereof used in the present invention has a buffering action in alkali, and it is presumed that the buffering action inhibits the aging of noodles.

### EXAMPLES

The present invention will now be further illustrated by, but is by no means limited to, the following Examples.

### Comparative Example 1

Strong wheat flour (250 g), a water (90 mL) which contains brine (5.95% by weight), and a salt (2 g) were mixed for 5 minutes to obtain 1.6 mm square noodles by using a noodle maker HR2365/01 (Phillips). The resulting noodles were aged for 2 days in a refrigerator to obtain raw Chinese noodles.

### Example 1

The procedures of Comparative Example 1 were repeated, except for using glycine (3.42 g) (1.0% by weight with respect to the total weight), to obtain raw Chinese noodles.

### Example 2

The procedures of Example 1 were repeated, except for using glycine (10.26 g) (3.0% by weight with respect to the total weight), to obtain raw Chinese noodles.

### Example 3

The procedures of Example 1 were repeated, except for using glycine (17.10 g) (5.0% by weight with respect to the total weight), to obtain raw Chinese noodles.

### Evaluation Method

The raw Chinese noodles obtained in the above Comparative Example and Examples were cooked in boiling water for 1 minute 45 seconds, transferred to a bowl containing ramen soup, and evaluated by five testers.

For the firmness, the noodles in Comparative Example 1 were used as a benchmark, and the differences thereof were compared and evaluated.

TABLE 1

| | | | Same as | | | | |
|---|---|---|---|---|---|---|---|
| Experimental | | | benchmark | Slightly | | Significantly | Total |
| section | Glycine | | (hard) | soft | Soft | soft | evaluation |
| Comparative | 0 | wt % | 5 | | | | |
| Example 1 | | | | | | | |
| Example 1 | 1.0 | wt % | | | 5 | | Soft |
| Example 2 | 3.0 | wt % | | | | 5 | Significantly |
| | | | | | | | soft |
| Example 3 | 5.0 | wt % | | | | 5 | Significantly |
| | | | | | | | soft |

### Comparative Example 2

Strong wheat flour (250 g), a water (90 mL) which contains brine (5.95% by weight), and a salt (2 g) were mixed for 5 minutes to obtain 1.6 mm square noodles by using a noodle maker HR2365/01 (Phillips). The resulting noodles were aged for 3 days in a refrigerator to obtain raw Chinese noodles.

### Example 4

The procedures of Comparative Example 2 were repeated, except for using glycine (1.026 g) (0.3% by weight), to obtain raw Chinese noodles.

### Example 5

The procedures of Comparative Example 2 were repeated, except for using glycine (1.710 g) (0.5% by weight), to obtain raw Chinese noodles.

The procedures of Comparative Example 2 were repeated, except for using glycine (2.394 g) (0.7% by weight), to obtain raw Chinese noodles.

### Evaluation Method

The raw Chinese noodles obtained in the above Comparative Example and Examples were cooked in boiling water for 2 minutes, transferred to a bowl containing ramen soup, and evaluated by five testers.

For the firmness, noodles in Comparative Example 2 were used as a benchmark, and the differences thereof were compared and evaluated.

TABLE 2

| | | | Same as | | | | |
|---|---|---|---|---|---|---|---|
| Experimental | | | benchmark | Slightly | | Significantly | Total |
| section | Glycine | | (hard) | soft | Soft | soft | evaluation |
| Comparative | 0 | wt % | 5 | | | | |
| Example 2 | | | | | | | |
| Example 4 | 0.3 | wt % | 1 | 4 | | | Slightly soft |
| Example 5 | 0.5 | wt % | | 4 | 1 | | Slightly soft |
| Example 6 | 0.7 | wt % | | | 5 | | Soft |

### Comparative Example 3

Strong wheat flour (250 g), a water (90 mL) which contains brine (5.95% by weight), and a salt (2 g) were mixed for 5 minutes to obtain 1.6 mm square noodles by using a noodle maker HR2365/01 (Phillips). The resulting noodles were aged for 1 day at room temperature and for 2 days in a refrigerator to obtain raw Chinese noodles.

### Example 7

The procedures of Comparative Example 3 were repeated, except for using glycine (1.026 g) (0.3% by weight), to obtain raw Chinese noodles.

### Example 8

The procedures of Comparative Example 3 were repeated, except for using glycine (1.710 g) (0.5% by weight), to obtain raw Chinese noodles.

### Example 9

The procedures of Comparative Example 3 were repeated, except for using glycine (2.394 g) (0.7% by weight), to obtain raw Chinese noodles.

### Evaluation Method

The raw Chinese noodles obtained in the above Comparative Example and Examples were cooked in boiling water for 2 minutes, transferred to a bowl containing ramen soup, and evaluated by five testers.

For the firmness, noodles in Comparative Example 3 were used as a benchmark, and the differences thereof were compared and evaluated.

TABLE 3

| | | | Same as | | | | |
|---|---|---|---|---|---|---|---|
| Experimental | | | benchmark | Slightly | | Significantly | Total |
| section | Glycine | | (hard) | soft | Soft | soft | evaluation |
| Comparative | 0 | wt % | 5 | | | | |
| Example 3 | | | | | | | |
| Example 7 | 0.3 | wt % | 5 | | | | Same as |
| | | | | | | | benchmark |
| Example 8 | 0.5 | wt % | | 5 | | | Slightly soft |
| Example 9 | 0.7 | wt % | | 3 | 2 | | Slightly soft |

### Comparative Example 4

Strong wheat flour (250 g), a water (90 mL) which contains brine (5.95% by weight), and a salt (2 g) were mixed for 5 minutes to obtain 1.6 mm square noodles by using a noodle maker HR2365/01 (Phillips). The resulting noodles were aged for 3 days in a refrigerator to obtain raw Chinese noodles.

### Example 10

The procedures of Comparative Example 4 were repeated, except for using glycine (3.42 g) (1.0% by weight with respect to the total weight), to obtain raw Chinese noodles.

### Example 11

The procedures of Comparative Example 4 were repeated, except for using glycine (6.84 g) (2.0% by weight with respect to the total weight), to obtain raw Chinese noodles.

### Example 12

The procedures of Comparative Example 4 were repeated, except for using glycine (10.26 g) (3.0% by weight with respect to the total weight), to obtain raw Chinese noodles.

### Evaluation Method

The raw Chinese noodles obtained in the above Comparative Example and Examples were cooked in boiling water for 2 minutes, transferred to a bowl containing ramen soup, and evaluated by three testers.

For the firmness, noodles in Comparative Example 4 were used as a benchmark, and the differences thereof were compared and evaluated.

TABLE 4

| | | | Same as | | | | |
|---|---|---|---|---|---|---|---|
| Experimental | | | benchmark | Slightly | | Significantly | Total |
| section | Glycine | | (hard) | soft | Soft | soft | evaluation |
| Comparative | 0 | wt % | 3 | | | | |
| Example 4 | | | | | | | |
| Example 10 | 1.0 | wt % | | 1 | 2 | | Soft |
| Example 11 | 2.0 | wt % | | | 3 | | Soft |
| Example 12 | 3.0 | wt % | | | | 3 | Significantly |
| | | | | | | | soft |

### Comparative Example 5

Strong wheat flour (250 g), a water (90 mL) which contains brine (5.95% by weight), and a salt (2 g) were mixed for 5 minutes to obtain 1.6 mm square noodles by using a noodle maker HR2365/01 (Phillips). The resulting noodles were aged for 1 day at room temperature and for 2 days in a refrigerator to obtain raw Chinese noodles.

### Example 13

The procedures of Comparative Example 5 were repeated, except for using glycine (3.42 g) (1.0% by weight with respect to the total weight), to obtain raw Chinese noodles.

### Example 14

The procedures of Comparative Example 5 were repeated, except for using glycine (6.84 g) (2.0% by weight with respect to the total weight), to obtain raw Chinese noodles.

### Example 15

The procedures of Comparative Example 5 were repeated, except for using glycine (10.26 g) (3.0% by weight with respect to the total weight), to obtain raw Chinese noodles.

### Evaluation Method

The raw Chinese noodles obtained in the above Comparative Example and Examples were cooked in boiling water for 2 minutes, transferred to a bowl containing ramen soup, and evaluated by five testers.

For the firmness, noodles in Comparative Example 5 were used as a benchmark, and the differences thereof were compared and evaluated.

TABLE 5

| | | | Same as | | | | |
|---|---|---|---|---|---|---|---|
| Experimental | | | benchmark | Slightly | | Significantly | Total |
| section | Glycine | | (hard) | soft | Soft | soft | evaluation |
| Comparative | 0 | wt % | 5 | | | | |
| Example 5 | | | | | | | |
| Example 13 | 1.0 | wt % | | 1 | 4 | | Soft |
| Example 14 | 2.0 | wt % | | | 4 | 1 | Soft |
| Example 15 | 3.0 | wt % | | | | 5 | Significantly |
| | | | | | | | soft |

### Comparative Example 6

Strong wheat flour (250 g), a water (90 mL) which contains brine (5.95% by weight), and a salt (2 g) were mixed for 5 minutes to obtain 1.6 mm square noodles by using a noodle maker HR2365/01 (Phillips). The resulting noodles were aged for 3 days in a refrigerator to obtain raw Chinese noodles.

### Example 16

The procedures of Comparative Example 6 were repeated, except for using glycine (1.02 g) (0.3% by weight with respect to the total weight), to obtain raw Chinese noodles.

### Evaluation Method

The raw Chinese noodles obtained in the above Comparative Example and Example were cooked in boiling water for 2 minutes, transferred to a bowl containing ramen soup, and evaluated by four testers.

For the firmness, noodles in Comparative Example 6 were used as a benchmark, and the differences thereof were compared and evaluated.

TABLE 6

| | | | Same as | | | | |
|---|---|---|---|---|---|---|---|
| Experimental | | | benchmark | Slightly | | Significantly | Total |
| section | Glycine | | (hard) | soft | Soft | soft | evaluation |
| Comparative | 0 | wt % | 4 | | | | |
| Example 6 | | | | | | | |
| Example 16 | 0.3 | wt % | 1 | 3 | | | Slightly soft |

### Comparative Example 7

Strong wheat flour (250 g), a water (90 mL) which contains brine (5.95% by weight), and a salt (2 g) were mixed for 5 minutes to obtain 1.6 mm square noodles by using a noodle maker HR2365/01 (Phillips). The resulting noodles were aged for 1 day at room temperature and for 2 days in a refrigerator to obtain raw Chinese noodles.

### Example 17

The procedures of Comparative Example 7 were repeated, except for using glycine (1.02 g) (0.3% by weight with respect to the total weight), to obtain raw Chinese noodles.

### Evaluation Method

The raw Chinese noodles obtained in the above Comparative Example and Example were cooked in boiling water for 2 minutes, transferred to a bowl containing ramen soup, and evaluated by three testers.

For the firmness, noodles in Comparative Example 7 were used as a benchmark, and the differences thereof were compared and evaluated.

TABLE 7

| | | | Same as | | | | |
|---|---|---|---|---|---|---|---|
| Experimental | | | benchmark | Slightly | | Significantly | Total |
| section | Glycine | | (hard) | soft | Soft | soft | evaluation |
| Comparative | 0 | wt % | 3 | | | | |
| Example 7 | | | | | | | |
| Example 17 | 0.3 | wt % | 1 | 2 | | | Slightly soft |

### Comparative Example 8

Strong wheat flour (250 g), a water (90 mL) which contains brine (5.95% by weight), and a salt (2 g) were mixed for 5 minutes to obtain 1.6 mm square noodles by using a noodle maker HR2365/01 (Phillips). The resulting noodles were aged for 3 days in a refrigerator to obtain raw Chinese noodles.

### Example 18

The procedures of Comparative Example 8 were repeated, except for using DL-alanine (3.42 g) (1.0% by weight with respect to the total weight), to obtain raw Chinese noodles.

### Example 19

The procedures of Comparative Example 8 were repeated, except for using DL-alanine (6.84 g) (2.0% by weight with respect to the total weight), to obtain raw Chinese noodles.

### Example 20

The procedures of Comparative Example 8 were repeated, except for using DL-alanine (10.26 g) (3.0% by weight with respect to the total weight), to obtain raw Chinese noodles.

### Evaluation Method

The raw Chinese noodles obtained in the above Comparative Example and Examples were cooked in boiling water for 2 minutes, transferred to a bowl containing ramen soup, and evaluated by seven testers.

For the firmness, noodles in Comparative Example 8 were used as a benchmark, and the differences thereof were compared and evaluated.

TABLE 8

| | | | Same as | | | | |
|---|---|---|---|---|---|---|---|
| Experimental | | | benchmark | Slightly | | Significantly | Total |
| section | DL-alanine | | (hard) | soft | Soft | soft | evaluation |
| Comparative | 0 | wt % | 7 | | | | |
| Example 8 | | | | | | | |
| Example 18 | 1.0 | wt % | | 2 | 5 | | Soft |
| Example 19 | 2.0 | wt % | | | 7 | | Soft |
| Example 20 | 3.0 | wt % | | | | 7 | Significantly |
| | | | | | | | soft |

### Comparative Example 9

Strong wheat flour (250 g), a water (90 mL) which contains brine (5.95% by weight), and a salt (2 g) were mixed for 5 minutes to obtain 1.6 mm square noodles by using a noodle maker HR2365/01 (Phillips). The resulting noodles were aged for 1 day at room temperature and for 2 days in a refrigerator to obtain raw Chinese noodles.

### Example 21

The procedures of Comparative Example 9 were repeated, except for using DL-alanine (3.42 g) (1.0% by weight with respect to the total weight), to obtain raw Chinese noodles.

### Example 22

The procedures of Comparative Example 9 were repeated, except for using DL-alanine (6.84 g) (2.0% by weight with respect to the total weight), to obtain raw Chinese noodles.

### Example 23

The procedures of Comparative Example 9 were repeated, except for using DL-alanine (10.26 g) (3.0% by weight with respect to the total weight), to obtain raw Chinese noodles.

### Evaluation Method

The raw Chinese noodles obtained in the above Comparative Example and Examples were cooked in boiling water for 2 minutes, transferred to a bowl containing ramen soup, and evaluated by four testers.

For the firmness, noodles in Comparative Example 9 were used as a benchmark, and the differences thereof were compared and evaluated.

TABLE 9

| | | | Same as | | | | |
|---|---|---|---|---|---|---|---|
| Experimental | | | benchmark | Slightly | | Significantly | Total |
| section | DL-alanine | | (hard) | soft | Soft | soft | evaluation |
| Comparative | 0 | wt % | 4 | | | | |
| Example 9 | | | | | | | |
| Example 21 | 1.0 | wt % | | 2 | 2 | | Soft |
| Example 22 | 2.0 | wt % | | | 4 | | Soft |
| Example 23 | 3.0 | wt % | | | | 4 | Significantly |
| | | | | | | | soft |

### Comparative Example 10

Strong wheat flour (250 g), a water (90 mL) which contains brine (5.95% by weight), and a salt (2 g) were mixed for 5 minutes to obtain 1.6 mm square noodles by using a noodle maker HR2365/01 (Phillips). The resulting noodles were aged for 3 days in a refrigerator to obtain raw Chinese noodles.

### Example 24

The procedures of Comparative Example 10 were repeated, except for using monosodium L-glutamate (3.42 g) (1.0% by weight with respect to the total weight), to obtain raw Chinese noodles.

### Example 25

The procedures of Comparative Example 10 were repeated, except for using monosodium L-glutamate (6.84 g) (2.0% by weight with respect to the total weight), to obtain raw Chinese noodles.

### Example 26

The procedures of Comparative Example 10 were repeated, except for using monosodium L-glutamate (10.26 g) (3.0% by weight with respect to the total weight), to obtain raw Chinese noodles.

### Evaluation Method

The raw Chinese noodles obtained in the above Comparative Example and Examples were cooked in boiling water for 2 minutes, transferred to a bowl containing ramen soup, and evaluated by four testers.

For the firmness, noodles in Comparative Example 10 were used as a benchmark, and the differences thereof were compared and evaluated.

TABLE 10

| | | | Same as | | | | |
|---|---|---|---|---|---|---|---|
| Experimental | Monosodium | | benchmark | Slightly | | Significantly | Total |
| section | L-glutamate | | (hard) | soft | Soft | soft | evaluation |
| Comparative | 0 | wt % | 4 | | | | |
| Example 10 | | | | | | | |
| Example 24 | 1.0 | wt % | | | 4 | | Soft |
| Example 25 | 2.0 | wt % | | | 4 | | Soft |
| Example 26 | 3.0 | wt % | | | | 4 | Significantly |
| | | | | | | | soft |

### Comparative Example 11

Strong wheat flour (250 g), a water (90 mL) which contains brine (5.95% by weight), and a salt (2 g) were mixed for 5 minutes to obtain 1.6 mm square noodles by using a noodle maker HR2365/01 (Phillips). The resulting noodles were aged for 1 day at room temperature and for 2 days in a refrigerator to obtain raw Chinese noodles.

### Example 27

The procedures of Comparative Example 11 were repeated, except for using monosodium L-glutamate (3.42 g) (1.0% by weight with respect to the total weight), to obtain raw Chinese noodles.

### Example 28

The procedures of Comparative Example 11 were repeated, except for using monosodium L-glutamate (6.84 g) (2.0% by weight with respect to the total weight), to obtain raw Chinese noodles.

### Example 29

The procedures of Comparative Example 11 were repeated, except for using monosodium L-glutamate (10.26 g) (3.0% by weight with respect to the total weight), to obtain raw Chinese noodles.

### Evaluation Method

The raw Chinese noodles obtained in the above Comparative Example and Examples were cooked in boiling water for 2 minutes, transferred to a bowl containing ramen soup, and evaluated by five testers.

For the firmness, noodles in Comparative Example 11 were used as a benchmark, and the differences thereof were compared and evaluated.

TABLE 11

| | | | Same as | | | | |
|---|---|---|---|---|---|---|---|
| Experimental | Monosodium | | benchmark | Slightly | | Significantly | Total |
| section | L-glutamate | | (hard) | soft | Soft | soft | evaluation |
| Comparative | 0 | wt % | 5 | | | | |
| Example 11 | | | | | | | |
| Example 27 | 1.0 | wt % | | | 5 | | Soft |
| Example 28 | 2.0 | wt % | | | 5 | | Soft |
| Example 29 | 3.0 | wt % | | | | 5 | Significantly |
| | | | | | | | soft |

### Comparative Example 12

Strong wheat flour (250 g), a water (90 mL) which contains brine (5.95% by weight), and a salt (2 g) were mixed for 5 minutes to obtain 1.6 mm square noodles by using a noodle maker HR2365/01 (Phillips). The resulting noodles were aged for 1 day at room temperature and for 2 days in a refrigerator to obtain raw Chinese noodles.

### Example 30

The procedures of Comparative Example 12 were repeated, except for using glycine (3.42 g) (1.0% by weight with respect to the total weight), to obtain raw Chinese noodles.

The procedures of Comparative Example 12 were repeated, except for using DL-alanine (3.42 g) (1.0% by weight with respect to the total weight), to obtain raw Chinese noodles.

### Example 32

The procedures of Comparative Example 12 were repeated, except for using monosodium L-glutamate (3.42 g) (1.0% by weight with respect to the total weight), to obtain raw Chinese noodles.

### Evaluation Method

The raw Chinese noodles obtained in the above Comparative Example and Examples were cooked in boiling water for 2 minutes, transferred to a bowl containing ramen soup, and evaluated by four testers.

For the firmness, noodles in Comparative Example 12 were used as a benchmark, and the differences thereof were compared and evaluated.

TABLE 12

| | | Same as | | | | |
|---|---|---|---|---|---|---|
| Experimental | | benchmark | Slightly | | Significantly | Total |
| section | | (hard) | soft | Soft | soft | evaluation |
| Comparative | 0 wt % | 4 | | | | |
| Example 12 | | | | | | |
| Example 30 | Glycine | | | 4 | | Soft |
| | 1.0 wt % | | | | | |
| Example 31 | DL-alanine | | 2 | 2 | | Soft |
| | 1.0 wt % | | | | | |
| Example 32 | Monosodium | | | 4 | | Soft |
| | L-glutamate | | | | | |
| | 1.0 wt % | | | | | |

### Comparative Example 13

Strong wheat flour (250 g), a water (90 mL) which contains brine (5.95% by weight), and a salt (2 g) were mixed for 5 minutes to obtain 1.6 mm square noodles by using a noodle maker HR2365/01 (Phillips). The resulting noodles were aged for 3 days in a refrigerator to obtain raw Chinese noodles.

### Example 33

The procedures of Comparative Example 13 were repeated, except for using glycine (3.42 g) (1.0% by weight with respect to the total weight), to obtain raw Chinese noodles.

### Example 34

The procedures of Comparative Example 13 were repeated, except for using L-glutamine (3.42 g) (1.0% by weight with respect to the total weight), to obtain raw Chinese noodles.

### Example 35

The procedures of Comparative Example 13 were repeated, except for using monosodium L-glutamate (3.42 g) (1.0% by weight with respect to the total weight), to obtain raw Chinese noodles.

### Example 36

The procedures of Comparative Example 13 were repeated, except for using monosodium L-threonine (3.42 g) (1.0% by weight with respect to the total weight), to obtain raw Chinese noodles.

### Example 37

The procedures of Comparative Example 13 were repeated, except for using L-histidine (3.42 g) (1.0% by weight with respect to the total weight), to obtain raw Chinese noodles.

### Example 38

The procedures of Comparative Example 13 were repeated, except for using sodium L-aspartate (3.42 g) (1.0% by weight with respect to the total weight), to obtain raw Chinese noodles.

The procedures of Comparative Example 13 were repeated, except for using GABA (3.42 g) (1.0% by weight with respect to the total weight), to obtain raw Chinese noodles.

### Evaluation Method

The raw Chinese noodles obtained in the above Comparative Example and Examples were cooked in boiling water for 2 minutes, transferred to a bowl containing ramen soup, and evaluated by five testers.

For the firmness, noodles in Comparative Example 13 were used as a benchmark, and the differences thereof were compared and evaluated.

TABLE 13

| | | Same as | | | | |
|---|---|---|---|---|---|---|
| Experimental | | benchmark | Slightly | | Significantly | Total |
| section | | (hard) | soft | Soft | soft | evaluation |
| Comparative | 0 wt % | 5 | | | | |
| Example 13 | | | | | | |
| Example 33 | Glycine | | | 5 | | Soft |
| | 1.0 wt % | | | | | |
| Example 34 | L-glutamine | | 4 | 1 | | Slightly soft |
| | 1.0 wt % | | | | | |
| Example 35 | Monosodium | | | | 5 | Significantly |
| | L-glutamate | | | | | soft |
| | 1.0 wt % | | | | | |
| Example 36 | L-threonine | | | | 5 | Significantly |
| | 1.0 wt % | | | | | soft |
| Example 37 | L-histidine | 1 | 3 | 1 | | Slightly soft |
| | 1.0 wt % | | | | | |
| Example 38 | L-sodium | | 1 | 4 | | Soft |
| | asparate | | | | | |
| | 1.0 wt % | | | | | |
| Example 39 | GABA | 1 | 2 | 2 | | Slightly soft |
| | 1.0 wt % | | | | | |

### Comparative Example 14

Strong wheat flour (250 g), a water (90 mL) which contains brine (5.95% by weight), and a salt (2 g) were mixed for 5 minutes to obtain 1.6 mm square noodles by using a noodle maker HR2365/01 (Phillips). The resulting noodles were aged for 8 days in a refrigerator to obtain raw Chinese noodles.

### Example 40

The procedures of Comparative Example 14 were repeated, except for using glycine (1.71 g) (0.5% by weight with respect to the total weight), to obtain raw Chinese noodles.

### Example 41

The procedures of Comparative Example 14 were repeated, except for using glycine (3.42 g) (1.0% by weight with respect to the total weight), to obtain raw Chinese noodles.

### Example 42

The procedures of Comparative Example 14 were repeated, except for using glycine (6.84 g) (2.0% by weight with respect to the total weight), to obtain raw Chinese noodles.

### Evaluation Method

The raw Chinese noodles obtained in the above Comparative Example and Examples were cooked in boiling water for 2 minutes, transferred to a bowl containing ramen soup, and evaluated by four testers.

For the firmness, noodles in Comparative Example 14 were used as a benchmark, and the differences thereof were compared and evaluated.

TABLE 14

| | | | Same as | | | | |
|---|---|---|---|---|---|---|---|
| Experimental | | | benchmark | Slightly | | Significantly | Total |
| section | Glycine | | (hard) | soft | Soft | soft | evaluation |
| Comparative | 0 | wt % | 4 | | | | |
| Example 14 | | | | | | | |
| Example 40 | 0.5 | wt % | 3 | 1 | | | Same as |
| | | | | | | | benchmark |
| Example 41 | 1.0 | wt % | | 4 | | | Slightly soft |
| Example 42 | 2.0 | wt % | | | 4 | | Soft |

### Comparative Example 15

Wheat flour (80 kg), a water (24.0357 kg) (which contains about 1.76% of brine), and a salt (1408 g) were mixed, rolled, and cut to obtain noodles. The resulting noodles were aged for 1 day or 3 days to obtain raw Chinese noodles.

The procedures of Comparative Example 15 were repeated, except for using glycine (800 g) (0.25% by weight with respect to the total weight), to obtain raw Chinese noodles.

### Evaluation Method

The raw Chinese noodles obtained in the above Comparative Example and Example were cooked and evaluated by two testers.

An appearance, a texture, and a growth were evaluated.

TABLE 15

| Experimental | | | | | | | |
|---|---|---|---|---|---|---|---|
| section | Aging period | | Glycine | | Appearence | Texture | Growth |
| Comparative | 1 | day | 0 | wt. % | Standarad | Standarad (hard) | Not feel growth |
| Example 15 | | | | | | | |
| Example 43 | 1 | day | 0.25 | wt. % | Standarad | Soft in excess | Soft at first |
| | | | | | | | Not feel growth |
| Comparative | 3 | days | 0 | wt. % | Standarad | Hard surface | Not feel growth |
| Example 15 | | | | | | | |
| Example 43 | 3 | days | 0.25 | wt. % | Standarad | Soft in excess | Soft at first |
| | | | | | | Not hard surface | Not feel growth |

### Comparative Example 16

Wheat flour (80 kg), a water (24.0357 kg) (which contains about 1.76% of brine), and a salt (1408 g) were mixed, rolled, and cut to obtain noodles. The resulting noodles were frozen for 2 days and thawed to obtain raw Chinese noodles.

### Example 44

Wheat flour (10 kg), a water (3.0045 kg), and a salt (176 g) were mixed to obtain noodles by a conventional method. Brine (52.9 g)(1.76% in water) and glycine (50 g)(0.38% by weight with respect to the total weight) were sprinkled to obtain raw Chinese noodles.

### Evaluation Method

The raw Chinese noodles obtained in the above Comparative Example and Example were cooked and evaluated by a tester.

An appearance, a texture, and a growth were evaluated.

TABLE 16

| Experimental | Storage period | | | | | | |
|---|---|---|---|---|---|---|---|
| section | after thawing | | Glycine | | Appearence | Texture | Growth |
| Comparative | 0 | day | 0 | wt. % | Standarad | Standard (hard) | Not feel growth |
| Example 16 | | | | | | | |
| Example 44 | 0 | day | 0.38 | wt. % | Transparent | Slight hardness inside | Soft at first |
| | | | | | | but soft | Not feel growth |
| Comparative | 2 | weeks | 0 | wt. % | Standarad | Notable hardness of | Not feel growth |
| Example 16 | | | | | | surface | |
| Example 44 | 2 | weeks | 0.38 | wt. % | Transparent | Soft but slightly hard | Soft at first |
| | | | | | | surface | Not feel growth |

1. A hardening inhibitor of brine-containing noodles or a brine-containing wonton wrapper, comprising an α-amino acid, a β-amino acid, or a γ-amino acid, or a salt thereof.

2. The hardening inhibitor of brine-containing noodles or a brine-containing wonton wrapper according to claim 1, comprising the α-amino acid or the salt thereof.

3. Use of an α-amino acid, a β-amino acid, or a γ-amino acid, or a salt thereof, for inhibiting hardening of brine-containing noodles or a brine-containing wonton wrapper.

4. The use according to claim 3, of the α-amino acid or the salt thereof, for inhibiting hardening of the brine-containing noodles or the brine-containing wonton wrapper.

5. A method for inhibiting hardening of brine-containing noodles or a brine-containing wonton wrapper, characterized in that an α-amino acid, a β-amino acid, or a γ-amino acid, or a salt thereof is added to the brine-containing noodles or the brine-containing wonton wrapper, for inhibiting hardening of the brine-containing noodles or the brine-containing wonton wrapper.

6. The method for inhibiting hardening of brine-containing noodles or a brine-containing wonton wrapper according to claim 5, characterized in that the α-amino acid or the salt thereof is added to the brine-containing noodles or the brine-containing wonton wrapper, for inhibiting hardening of the brine-containing noodles or the brine-containing wonton wrapper.

7. The method for inhibiting hardening of brine-containing noodles or a brine-containing wonton wrapper according to claim 5, the addition amount of the α-amino acid, the β-amino acid, or the γ-amino acid, or the salt thereof with respect to a total weight of the brine-containing noodles is 0.3% by weight to 3% by weight.

8. The method for inhibiting hardening of brine-containing noodles or a brine-containing wonton wrapper according to claim 6, the addition amount of the α-amino acid or the salt thereof with respect to a total weight of the brine-containing noodles is 0.3% by weight to 3% by weight.
